(19) United States
(12) Patent Application Publication
(10) Pub. No.: US 2026/0243877 A1
(43) Pub. Date: Aug. 20, 2026

(54) RADAR APPARATUS AND METHOD FOR OPERATING A RADAR APPARATUS

(71) Applicant: Robert Bosch GmbH, Stuttgart (DE)

(72) Inventors: Daniel Schindler, Korntal-Münchingen (DE); Juergen Hasch, Stuttgart (DE); Markus Gonser, Albstadt-Laufen (DE); Martin Fink, Leonberg (DE)

(21) Appl. No.: 19/475,342

(22) PCT Filed: Apr. 12, 2024
(86) PCT No.: PCT/EP2024/059984

§ 371 Date: Jan. 26, 2026

(30) Foreign Application Priority Data
Apr. 28, 2023 (DE) 10 2023 203 974.5

(51) Int. Cl. G01S 13/34; G01S 7/03; G01S 7/35; G01S 13/931

(52) U.S. Cl. CPC G01S 13/345; G01S 7/032; G01S 7/358; G01S 13/347; G01S 13/931

(57) ABSTRACT

A radar apparatus having a local oscillator which generates a local oscillator signal having a constant frequency. The radar apparatus also includes at least one device which transmits radar signals and/or receives radar signals. The device has a ramp generator which, depending on the local oscillator signal, generates a ramp signal and distributes the signal within the device.

### FIELD

The present invention relates to a radar apparatus and to a method for operating a radar apparatus.

### BACKGROUND INFORMATION

Radar measurement technology is used alongside other measurement principles to record the environment in automotive, industrial, or consumer applications. Radar sensors use electromagnetic waves propagating at the speed of light to perform measurements by measuring the time interval from a transmitted signal to a point of reflection and back, i.e., the echo arrival time. From this time of flight, the range and/or relative velocity of the reflection point with respect to the sensor can then be determined.

A common operating method for radar sensors is the FMCW (frequency-modulated continuous wave) method, in which a single carrier is linearly modulated in its frequency and transmitted. The echo reflected from the reflection points is then mixed with the modulated carrier in the receiver channels of the radar sensor, resulting in an intermediate frequency proportional to the radial distance of the reflection point. The intermediate frequency can be determined, for example, by a fast Fourier transform. To determine the radial velocity, a plurality of frequency-modulated carriers can be transmitted and received one after the other, the frequency shift of which over time corresponds to the Doppler frequency, from which the relative velocity can be calculated.

To determine the angle of the reflection point, a plurality of transmitter and receiver channels can be used within a single radar sensor.

By suitably designing the antenna system, a virtual array consisting of N_{TX}. NRx channels can be formed, where N_{TX} denotes the number of transmitters and NRx denotes the number of recipients. Based on the phase difference between the individual echoes, it is possible to determine azimuth angles and/or elevation angles. This method is called the MIMO (multiple-input multiple-output) radar method.

In addition, phased array antennas are used in communication and radar applications. By means of phase shifters and, where appropriate, adjustable amplifiers in the transmitter channels, they allow for adaptive steering of the main beam direction of a multichannel radar system. Thus, the otherwise predetermined main beam direction of the radar sensor can be changed during operation.

U.S. Pat. No. 11,360,210 B2 describes a MIMO radar sensor in which the transmitter can be reconfigured to switch between different fields of view of the sensor.

The frequency ramp required for the FMCW radar can be adjusted by means of a phase-locked loop (PLL), which changes the output frequency over time. Due to the ramp linearity required to achieve the required sensitivity for the radar system, the phase-locked loop is very demanding and complex. With continuing advances in integration, broadband digital-to-analog converters and DDS (direct signal synthesis) converters are now available, so that the ramp can also be implemented without a phase-locked loop.

In Germany Patent Application No. DE 10 2016 224 945 A1, different ramp generators are used for the transmitting path and the receiving path, with different carrier frequencies being used for the transmitter channels.

### SUMMARY

The present invention provides a radar apparatus and a method for operating a radar apparatus.

Preferred embodiments of the present invention are disclosed herein.

According to a first aspect, the present invention relates to a radar apparatus having a local oscillator which generates a local oscillator signal having a constant frequency. The radar apparatus also comprises at least one device which transmits radar signals and/or receives radar signals. The device has a ramp generator which, depending on the local oscillator signal, generates a ramp signal and distributes the signal within the device.

According to a second aspect, the present invention relates to a method for operating a radar apparatus. A local oscillator signal having a constant frequency is generated here. Radar signals are transmitted and received by means of at least one device, wherein the device has a ramp generator which, depending on the local oscillator signal, generates a ramp signal and distributes said signal within the device.

The radar apparatus of the present invention may be integrated as a highly integrated semiconductor circuit. Preferably, a plurality of devices can be interconnected (cascaded). This makes it possible to increase the number of implementable transmitter and receiver channels for coherent angle measurement in radar sensors, which is particularly advantageous for high-performance FMCW radar sensors, which are also suitable, for example, for automotive applications in the area of increasing highly automated driving functions.

The local oscillator itself generates a signal having a constant frequency, which can more easily be distributed to the individual devices than an already modulated signal. The devices each have a ramp generator, so that the signal is modeled (i.e., the ramp is generated) separately in each device.

The radar apparatus may be designed as an FMCW radar apparatus without the need for a phase-locked loop for ramp generation. The local oscillator only needs to provide the local oscillator signal having a constant frequency, i.e., a fixed-frequency carrier, so that design parameters such as phase noise can be specifically optimized for this application. At the same time, the advantages of a conventional FMCW radar apparatus are retained, such as a narrow reception bandwidth and the proportionality between baseband frequency and the target's radial range in the measured scene (and thus the ability to perform range compression and to limit the measurement range by low-pass filtering). By using phase shifters and configurable amplifiers, conventional modulation concepts such as the separation of transmitter channels by phase change in code/Doppler methods or phased arrays can be realized.

The fixed-frequency local oscillator signal also allows for simplified cascading of a plurality of devices designed as integrated circuits in order to increase the number of transmitter or receiver channels of the radar apparatus.

According to one example embodiment of the radar apparatus of the present invention, the at least one device is a function block which comprises transmitting paths and/or receiving paths. A device may be implemented as an integrated semiconductor circuit.

According to one example embodiment of the radar apparatus of the present invention, there are a plurality of devices, which devices can be parameterized independently of one another, so that adaptively configurable multimode radar apparatuses can be realized.

According to one example embodiment of the present invention, the radar apparatus has a reference oscillator which is designed to generate a reference signal, wherein the local oscillator is designed to generate the local oscillator signal using the reference signal.

According to one example embodiment of the present invention, the radar apparatus has a clock generator which is designed to, depending on the reference signal, generate a clock signal and to output said clock signal to the at least one device. In addition to the local oscillator signal, the clock signal provides another signal which is also derived from the reference signal.

According to one example embodiment of the radar apparatus of the present invention, the ramp generator has at least one IQ mixer, wherein the local oscillator is designed to output the local oscillator signal to the IQ mixer. The IQ mixer is used to generate the ramp signal.

According to one example embodiment of the radar apparatus of the present invention, the ramp generator has at least two direct digital synthesis (DDS) devices. The at least two DDS devices control the IQ mixer. The DDS devices can be used for modulation. In particular, the ramp generator may have a first DDS device and a second DDS device. The first DDS device controls an I path of the IQ mixer. The second DDS device controls a Q path of the IQ mixer.

According to one example embodiment of the radar apparatus of the present invention, the at least one DDS device is designed to, depending on the clock signal generated by the clock generator, control the IQ mixer.

According to one example embodiment of the radar apparatus of the present invention, the ramp generator has a first digital-to-analog converter and a second digital-to-analog converter. The first digital-to-analog converter controls an I path of the IQ mixer. The second digital-to-analog converter controls a Q path of the IQ mixer.

According to one example embodiment of the radar apparatus of the present invention, the first digital-to-analog converter is designed to, depending on the clock signal generated by the clock generator, control the I-path of the IQ mixer. The second digital-to-analog converter is designed to, depending on the clock signal generated by the clock generator, control the Q path of the IQ mixer.

According to one example embodiment of the radar apparatus of the present invention, the local oscillator can change the frequency of the local oscillator signal stepwise. However, the local oscillator signal does not need to be modulated (e.g., it is not ramp-shaped).

According to one example embodiment of the radar apparatus of the present invention, there are a plurality of devices, and each device is formed on a separate semiconductor chip.

According to one example embodiment of the radar apparatus of the present invention, there are a plurality of devices, and distribution of the local oscillator signal from the local oscillator to the devices is asymmetrical. The ramp generators of the devices are designed to compensate for the asymmetric distribution of the local oscillator signal. For example, all devices transmit the same frequency ramp, wherein the distribution of the local oscillator signal is asymmetrical, for example by means of an asymmetric star or by means of a ring. The line geometries of the distribution of the local oscillator signal are known from the sensor design, which is why compensation is possible by changing the start time or start phase of the ramp generator, so that the desired signal is obtained after the mixing process. Calibration is possible, for example, during end-of-line antenna calibration.

According to one example embodiment of the radar apparatus of the present invention, when the local oscillator signal is distributed symmetrically among the devices, all of the devices of the radar apparatus use the same ramp configuration, including, for example, ramp start times, a start frequency, an end frequency, a ramp slope and/or a start phase.

According to one example embodiment of the radar apparatus of the present invention, at least two devices, and preferably a plurality of devices, are used, which are divided into at least two subsystems. Thus, a multimode radar apparatus is provided in which different modulations may be used in the subsystems. These are synchronized with one another in such a way that mutual interference is avoided. When using a suitable antenna system, scene-adaptive redistribution of existing channels is also possible. For example, a radar beam may be emitted constantly along the central axis (boresight) and at least one additional flexible radar beam may be provided.

According to one example embodiment of the radar apparatus of the present invention, there is only one device which has both transmitter channels and receiver channels. If this device is integrated together with a local oscillator and/or a reference oscillator as a semiconductor circuit, a complete FMCW radar system may be provided.

Further advantages, features, and details of the present invention will become apparent from the following description, in which various exemplary embodiments of the present invention are described in detail with reference to the figures.

### BRIEF DESCRIPTION OF THE DRAWINGS

FIG. 1 shows a radar apparatus according to one example embodiment of the present invention.

FIG. 2 shows a radar apparatus according to a further example embodiment of the present invention.

FIGS. 3A and 3B together show a radar apparatus according to a further example embodiment of the present invention.

FIG. 4 shows a flow chart of a method for operating a radar apparatus according to one example embodiment of the present invention.

In all figures, identical or functionally identical elements and apparatuses are provided with the same reference signs. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

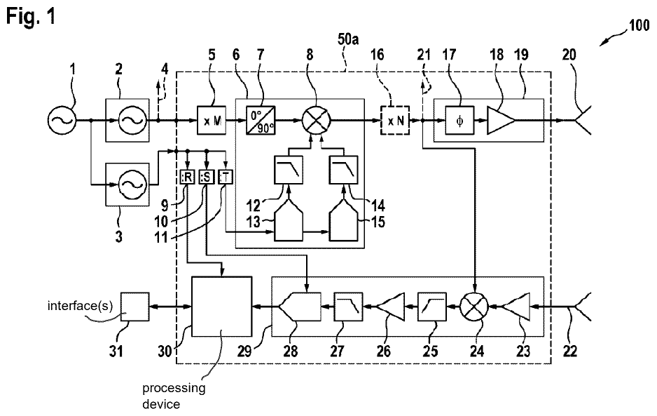

FIG. 1 shows a radar apparatus 100 having a reference oscillator 1 which generates a reference signal. The reference oscillator may, for example, be a quartz oscillator.

The radar apparatus 100 further comprises a local oscillator 2 which, using the reference signal, generates a local oscillator signal having a constant frequency. The local oscillator is a high-frequency source, e.g., based on a phase-locked loop, which operates, for example, in the range of 19 to 20.25 GHZ.

According to some embodiments, the local oscillator signal provided by the local oscillator 2 based on the reference signal of the reference oscillator 1 may be divided into time segments, each having a different frequency that is constant within the time segment.

The radar apparatus also comprises at least one, and preferably a plurality of, devices 50a, i.e., TX/RX blocks (transmitter/receiver blocks), which have transmitting devices for generating and transmitting radar signals and/or receiving devices for receiving radar signals.

Arbitrary combinations are possible. That is, some devices 50a may be designed only to generate and transmit radar signals, some devices 50a may be designed only to receive radar signals, and some devices 50a may be designed both to generate and transmit radar signals and to receive radar signals. An arbitrary combination of such devices 50a is possible. Each device 50a may be formed on a separate chip.

The local oscillator signal of the local oscillator 2 is distributed to all devices 50a. This can be done symmetrically or asymmetrically. FIG. 1 illustrates one of the devices 50a by way of example. The local oscillator signal is distributed via lines 4 to further devices that are not shown.

The device 50a optionally has a frequency multiplier 5 which multiplies the local oscillator signal by a multiplication factor M≥1, in particular M≥1, to the desired input frequency of a ramp generator 6.

The ramp generator 6 generates, depending the (optionally multiplied) local oscillator signal, a ramp signal, such as a chirp sequence, and distributes the ramp signal within the device 50a. “Distributing” means that the ramp signal is output to a plurality of components of the device 50a (e.g., transmitter channels and/or receiver channels). Accordingly, each device 50a comprises its own ramp generator 6 for applying modulation to the local oscillator signal.

The ramp generator 6 comprises a splitter 7 which splits the incoming signal into a signal in an I path and a signal in a Q path, which are shifted by 90 degrees in phase with each other. The ramp generator 6 also comprises an IQ mixer 8 which mixes the IQ signal with further provided signals, described below, and thereby generates the ramp signal.

The radar apparatus 100 comprises a clock generator 3 which, depending on the reference signal, generates and outputs a clock signal (e.g., a system clock). The clock signal may be independent of the local oscillator signal, i.e., in particular said clock signal may have an independent frequency.

The reference signal is provided to a processing device 30, a first direct digital synthesis (DDS) device 13 or a second DDS device 15 and an analog-to-digital converter 28 via optional frequency dividers 9, 10, 11 (with division factors R, S and T). Because all signals are derived from the clock signal, they are phase-locked to one another.

The first DDS device 13 and the second DDS device 15 generate signals which are filtered with low-pass filters 12 and 14, respectively, and mixed with the signal in the I path of the IQ mixer 8 and with the signal in the Q path of the IQ mixer 8, respectively.

In further embodiments, instead of the first DDS device 13 and the second DDS device 15, a first digital-to-analog converter 13 and a second digital-to-analog converter 15 are used.

In further embodiments, radio frequency digital-to-analog converters (RF DACs) are used instead of the first DDS device 13 and the second DDS device 15, whereby the IQ mixer 8 can be omitted.

Furthermore, the radar apparatus 100 comprises an optional frequency multiplier 16 having a multiplication factor N≥1, in particular where N≥1. For example, if the ramp generator 6 does not operate in the target frequency band, such as 76 to 81 GHZ for an automotive radar apparatus, the output signal is, before distribution to transmitter and/or receiver channels 19, 29, multiplied by the multiplication factor N into the target frequency band.

By means of the low-pass filters 12, 14, it can be ensured that the by the first DDS device 13 and the second DDS device 15 and, respectively, by the first digital-to-analog are adequately suppressed. Typical values for the sum of M and N are:

$$M + N = 1 … 16.$$

The modulated local oscillator signal in the target frequency band (i.e., the ramp signal) is then distributed within the device 50a via lines 21 to the transmitter and/or receiver channels 19, 29.

A transmitter channel 19 comprises a power amplifier 18 and a phase shifter 17, with which the transmitter channel 19 can be switched on, an output power can be adjusted, and, optionally, a relative phase of different transmitter channels 19 of the device 50a can be adjusted. The signal is transmitted via antennas 20.

The radar apparatus 100 may be operated using code or Doppler-based multiplexing methods. Furthermore, phased arrays may be realized, wherein a plurality of transmitter channels allow the main beam direction to be controlled or the side lobes to be suppressed.

In the receiver channels 29, the signal is received via antennas 22, optionally amplified by means of an amplifier 23 and fed to a receiving mixer 24, which mixes the received signal with the output signal of the ramp generator 6, which output signal was optionally multiplied by the frequency multiplier 16.

Because each device 50a has a ramp generator 6, it is possible to downmix the linear frequency-modulated transmission signal within the receiving mixers 24, as in conventional radar systems, using a frequency ramp with identical parameterization, thereby retaining the advantage of decoupling the radio frequency bandwidth from the baseband bandwidth. Accordingly, the configuration of the receiver channels 29 may substantially correspond to a conventional FMCW receiving path and may be implemented as narrowband on the baseband side, e.g., with a bandwidth in the range of 10 to 100 MHZ.

In addition, the proportionality of the baseband frequency and radial distance of each target is still maintained, so that high-pass filtering by a high-pass filter 25 and low-pass filtering by a low-pass filter 27 of the baseband signals for dynamic range limitation or for suppressing targets with a distance outside the parameterized measuring range is also possible. Between the high-pass filter 25 and the low-pass filter 27, the signal can be amplified by another amplifier 26. The signal is finally sampled by an analog-to-digital converter 28 and fed to the processing device 30.

Furthermore, synchronization or data exchange of the processing device 30 with other components may take place via interfaces 31.

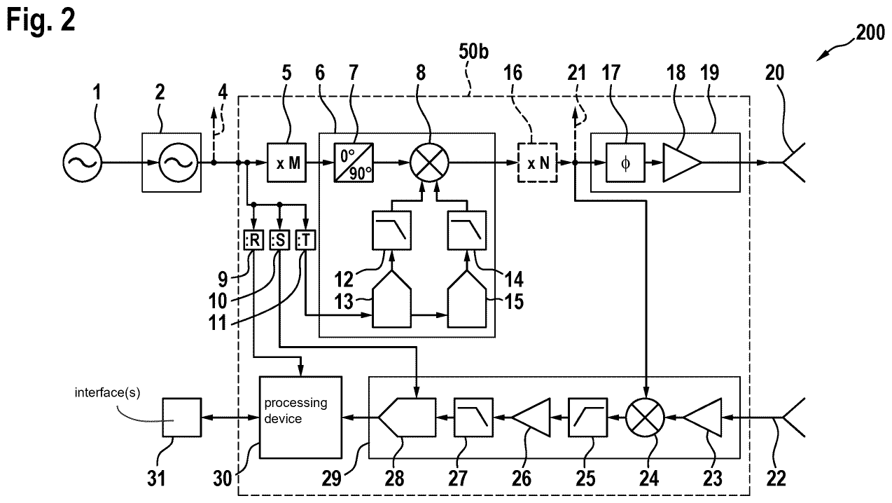

FIG. 2 shows a further radar apparatus 200. This radar apparatus differs from the radar apparatus 100 shown in FIG. 1 in that the radar apparatus 200 does not have a clock generator 3. Rather, the local oscillator signal from the local oscillator 2 is fed to the frequency dividers 9, 10, 11 and to the respective downstream components. This reduces the distribution effort for cascaded devices 50b. In particular, only one signal needs to be distributed to the individual devices 50b. In addition, the individual clock pulses are phase-locked not only to one another but also to the local oscillator signal. Optionally, each device 50b may also have a phase-locked loop which, based on the variable local oscillator signal, generates a fixed-frequency system clock pulse.

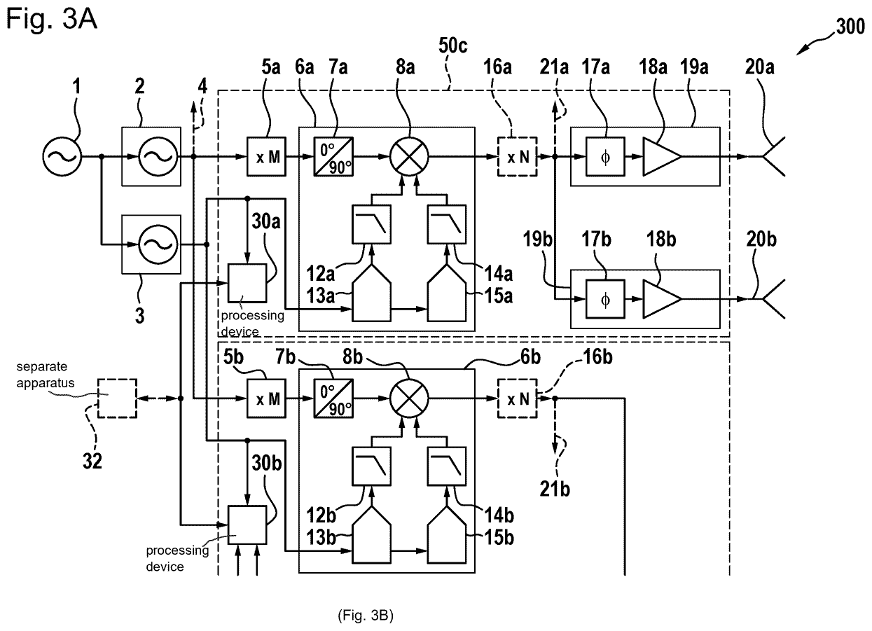

FIGS. 3A and 3B together show a further radar apparatus 300. This is a cascaded radar apparatus 300 having two devices 50c, 50d having separate transmitting devices 19a, 19b and receiving devices 29a, 29b.

Depending on the number of channels of the radar apparatus 300 and the higher-level system concept, the processing of the radar data may be carried out either within the devices 50c, 50d or in a separate apparatus 32.

The devices 50c, 50d each comprise optional frequency multipliers 5a, 5b and their own ramp generators 6a, 6b having the components described above, i.e., splitters 7a, 7b, IQ mixers 8a, 8b, low-pass filters 12a, 12b, 14a, 14b, a first DDS device 13a, 13b (or first digital-to-analog converter) and a second DDS device 15a, 15b (or second digital-to-analog converter). Furthermore, the devices 50c, 50d each comprise a processing device 30a, 30b and an optional frequency multiplier 16a, 16b, as well as lines 21a, 21b to transmitting and receiving paths, respectively.

The device 50c comprises first and second transmitter channels 19a, 19b, each having a power amplifier 18a, 18b and a phase shifter 1717a, 17b, as well as antennas 20a, 20b.

The device 50d comprises first and second receiver channels 29a, 29b, each having an amplifier 23a, 23b, a receiving mixer 24a, 24b, a high-pass filter 25a, 25b, an amplifier 26a, 26b, a low-pass filter 27a, 27b, and an analog-to-digital converter 28a, 28b.

Furthermore, a synchronization interface may be provided between the devices 50c, 50d, which allows for deterministic start times for the respective ramp generators 6a, 6b. A data interface allows for the exchange or forwarding of optionally pre-processed received signals to downstream processors. The devices 50c and 50d can also be configured via corresponding interfaces.

Independently of the embodiment, it is no longer necessary to distribute the modulated local oscillator signal between the individual devices 50a-50d (e.g., on a printed circuit board), but only a (at least stepwise) fixed-frequency local oscillator signal. This significantly simplifies distribution, in particular for sensors having a plurality of channels, because length differences in the local oscillator signal distribution and any resulting phase drift can be compensated for by re-parameterizing the ramp generators 6, i.e., their start phase and time.

Distribution of the local oscillator signal from the local oscillator to the devices may also be asymmetrical. The ramp generators 6, 6a, 6b of the devices 50a-50d are then designed to compensate for the asymmetric distribution of the local oscillator signal.

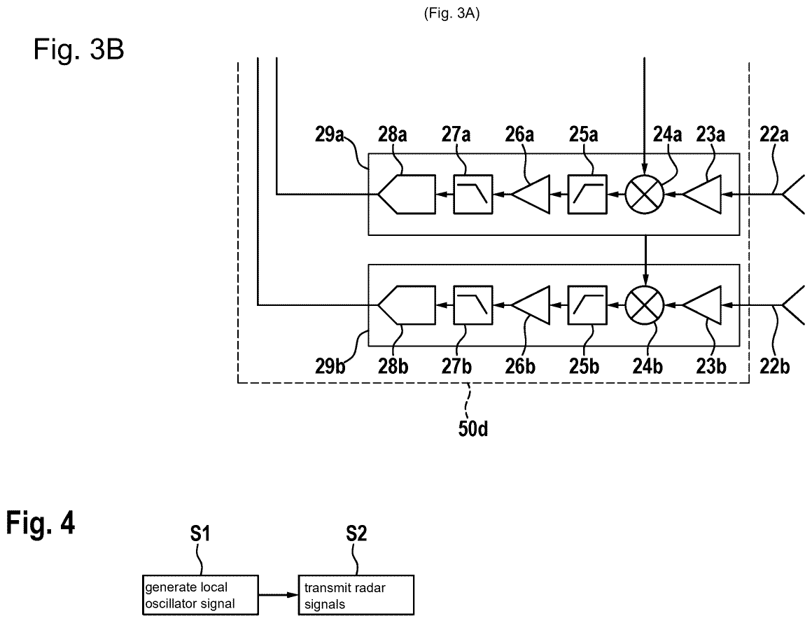

FIG. 4 shows a flow chart of a method for operating a radar apparatus, in particular one of the radar apparatuses 100, 200, 300 described above.

In a first step S1, a local oscillator signal having a constant frequency is generated. For this purpose, a local oscillator 2 as described above can be provided.

In a second step S2, radar signals are transmitted and received by means of at least one and preferably a plurality of devices 50a-50d, wherein each device 50a-50d has a ramp generator 6a-6d which, depending on the local oscillator signal, generates a ramp signal.

Furthermore, a reference oscillator 1 may be provided which generates a reference signal, wherein the local oscillator 2 generates the local oscillator signal using the reference signal.

A clock generator 3 may optionally be provided which is designed to, depending on the reference signal, generate a clock signal and to output said clock signal to the devices 50a-50d.

The ramp generators 6, 6a, 6b may each have an IQ mixer 8, 8a, 8b, wherein the local oscillator 2 outputs the local oscillator signal to the IQ mixer 8, 8a, 8b.

The ramp generators 6, 6a, 6b may each have at least one DDS device or at least one analog-to-digital converter 13, 15, 13a, 15a, 13b, 15b.

The local oscillator 2 may also be designed to change the frequency of the local oscillator signal stepwise.

Each device 50a-50d may be formed on a separate chip. Distribution of the local oscillator signal from the local oscillator 2 to the devices 50a-50d may also be asymmetrical, wherein the ramp generators 6, 6a, 6b of the devices 50a-50d compensate for the asymmetric distribution of the local oscillator signal.

1-11. (canceled)

12. A radar apparatus, comprising:
a local oscillator configured to generate a local oscillator signal having a constant frequency; and
at least one device configured to generate radar signals and/or to receive radar signals;
wherein the device includes a ramp generator which is configured to,
depending on the local oscillator signal, generate a ramp signal and to distribute the ramp signal within the device.

13. The radar apparatus according to claim 12, further comprising:
a reference oscillator configured to generate a reference signal, wherein the local oscillator configured to generate the local oscillator signal using the reference signal.

14. The radar apparatus according to claim 13, further comprising:
a clock generator configured to, depending on the reference signal, generate a clock signal and to output the clock signal to the device.

15. The radar apparatus according to claim 12, wherein the ramp generator includes an IQ mixer, and wherein the local oscillator is configured to output the local oscillator signal to the IQ mixer.

16. The radar apparatus according to claim 15, wherein the ramp generator includes at least two direct digital synthesis (DDS) devices, and wherein the at least two DDS devices are configured to control the IQ mixer.

17. The radar apparatus according to claim 14, wherein the ramp generator includes a first digital-to-analog converter and a second digital-to-analog converter, wherein the first digital-to-analog converter is configured to control an I path of the IQ mixer, and wherein the second digital-to-analog converter is configured to control a Q path of the IQ mixer.

18. The radar apparatus according to claim 17, wherein the first digital-to-analog converter and the second digital-to-analog converter are radio frequency digital-to-analog converters.

19. The radar apparatus according to claim 12, wherein the local oscillator is configured to change the frequency of the local oscillator signal stepwise.

20. The radar apparatus according to claim 12, wherein the device includes a plurality of devices, wherein each of the plurality of devices is formed on a separate chip relative to one another.

21. The radar apparatus according to claim 12, wherein the device includes a plurality of devices, wherein a distribution of the local oscillator signal from the local oscillator to the plurality of devices takes place asymmetrically, wherein each of the plurality of device includes a respective ramp generator configured to generate a respective ramp signal, and wherein the respective ramp generators of the plurality of devices are configured to compensate for asymmetric distribution of the local oscillator signal.

22. A method for operating a radar apparatus, comprising the following steps:
generating a local oscillator signal having a constant frequency; and
transmitting and receiving radar signals using at least one device, wherein each device of the at least one the device has a ramp generator which, depending on the local oscillator signal, generates a respective ramp signal and distributes the respective ramp signal within the device.
